(19) United States
(12) Patent Application Publication
(10) Pub. No.: US 2011/0261378 A1
(43) Pub. Date: Oct. 27, 2011

(54) PRINTING PROCESSING SYSTEM, PRINTING PROCESSING METHOD, AND IMAGE FORMING APPARATUS

(75) Inventor: Katsuyuki Taima, Hiratsuka-shi (JP)

(73) Assignee: Konica Minolta Business Technologies, Inc., Chiyoda-ku (JP)

(21) Appl. No.: 13/089,609

(22) Filed: Apr. 19, 2011

(30) Foreign Application Priority Data
Apr. 23, 2010 (JP) 2010-099937

(51) Int. Cl. G06K 15/22; B41F 19/00; G06F 3/12

(52) U.S. Cl. 358/1.12; 358/1.15; 358/1.18; 101/26

(57) ABSTRACT

The printing processing system of the present invention includes an image data generating unit for generating multiple types of image data, each of which corresponds to each individual purpose of document data, deriving from the document data; and a control unit for executing a control for performing a designated post-process on a sheet of paper on which an image is formed based on the specific type of image data among the multiple types of image data.

### CROSS-REFERENCE TO RELATED APPLICATION

This application is based on Japanese Patent Application No. 2010-099937 filed on Apr. 23, 2010, the contents of which are incorporated herein by reference.

### BACKGROUND

1. Technical Field

The present invention relates to a printing processing system, a printing processing method, and an image forming apparatus for executing a carbon copy printing process.

2. Description of Related Art

It is customary in a service business such as a home-delivery service to produce various copies of its transaction slip, e.g., “Customer Copy” and “Office Copy,” whose contents are identical to those of the original slip. It has been proposed in recent years to produce these multiple types of documents as a carbon copy printing using an image forming apparatus such as an MFP (Multi-Function Peripheral). According to a carbon copy printing, a user can produce multiple types of documents with a single printing instruction.

As a technology related to this, a printing control apparatus has been disclosed (see Unexamined Japanese Patent Publication No. 2007-213365) for controlling a carbon copy printing process by accepting the user's settings for a plurality of paper feeding trays for supplying sheets of paper and printing condition for each paper feeding tray concerning multiple sheets of paper on which images of identical contents will be printed. With the help of such a printing control apparatus, the user can set up paper type and color mode depending on the purpose of the sheet of paper on which images of identical contents will be printed. For example, the user can produce a “Customer Copy” by printing it in color on quality paper, while producing a “Office Copy” by printing it in monochrome on recycled paper.

In the meanwhile, in case of a conventional transaction slip, consisting of three slips, i.e., an original sales slip, a “Customer Copy” and an “Office Copy” placed on top of each other, only the “Office Copy” may have punched holes.

If one intends to form punched holes using the punch function provided on the MFP, however, it has a problem that the punched holes are formed uniformly on all three documents. In other words, it is undesirable to end up with unwanted punched holes on the “Customer Copy” in producing the set of three transaction slips by means of the carbon copy printing process.

Therefore, it is desirable in a carbon copy printing process to be able to perform a certain post-process such as the punching process only on a specific type of document among multiple types of documents which are produced for multiple purposes.

### SUMMARY

The present invention is made to solve the problem described above. An object of the present invention is to provide a printing processing system, a printing processing method, and an image forming apparatus that are capable of selectively performing a certain post-process on a specific type of document among multiple types of documents which are produced for multiple purposes in a carbon copy printing process.

To achieve at least one of the abovementioned objects, the printing processing system reflecting one aspect of the present invention includes: an image data generating unit for generating multiple types of image data, each of which corresponds to each individual purpose of document data, deriving from the document data; and a control unit for executing a control for performing a designated post-process on a sheet of paper on which an image is formed based on the specific type of image data among the multiple types of image data.

To achieve at least one of the abovementioned objects, the printing processing method reflecting one aspect of the present invention includes: (a) generating multiple types of image data, each of which corresponds to each individual purpose of document data, deriving from the document data; and (b) executing a control for performing a designated post-process on a sheet of paper on which an image is formed based on the specific type of image data among the multiple types of image data.

To achieve at least one of the abovementioned objects, the image forming apparatus reflecting one aspect of the present invention includes: an image data generating unit for generating multiple types of image data, each of which corresponds to each individual purpose of document data, deriving from the document data; a control unit for executing a control for performing a designated post-process on a sheet of paper on which an image is formed based on the specific type of image data among the multiple types of image data; an image forming unit for forming an image based on the image data; and a post-processing unit for performing the post-process on the sheet of paper on which the image is formed by the image forming unit.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall configuration of a printing processing system according to an embodiment of the present invention.

FIG. 2 is a schematic front view showing the configuration of the MFP shown in FIG. 1.

FIG. 3 is a block diagram showing the configuration of the MFP shown in FIG. 1.

FIG. 4 is a block diagram showing the configuration of the PC shown in FIG. 1.

FIG. 5 is a drawing showing an example of multiple types of documents produced by a carbon copy printing process.

FIG. 6 is a drawing showing an example of a printing setting screen displayed on the display of the PC.

FIG. 7 is a drawing showing an example of a carbon copy editing screen.

FIG. 8 is an example of printing setting information.

FIG. 9 is a flowchart showing a procedure of the printing process executed on the MFP.

FIG. 10 is a flowchart showing a procedure of the carbon copy printing instruction process shown in step S103 of FIG. 9.

### DETAILED DESCRIPTION

The embodiments of the present invention will be described below with reference to the accompanying drawings.

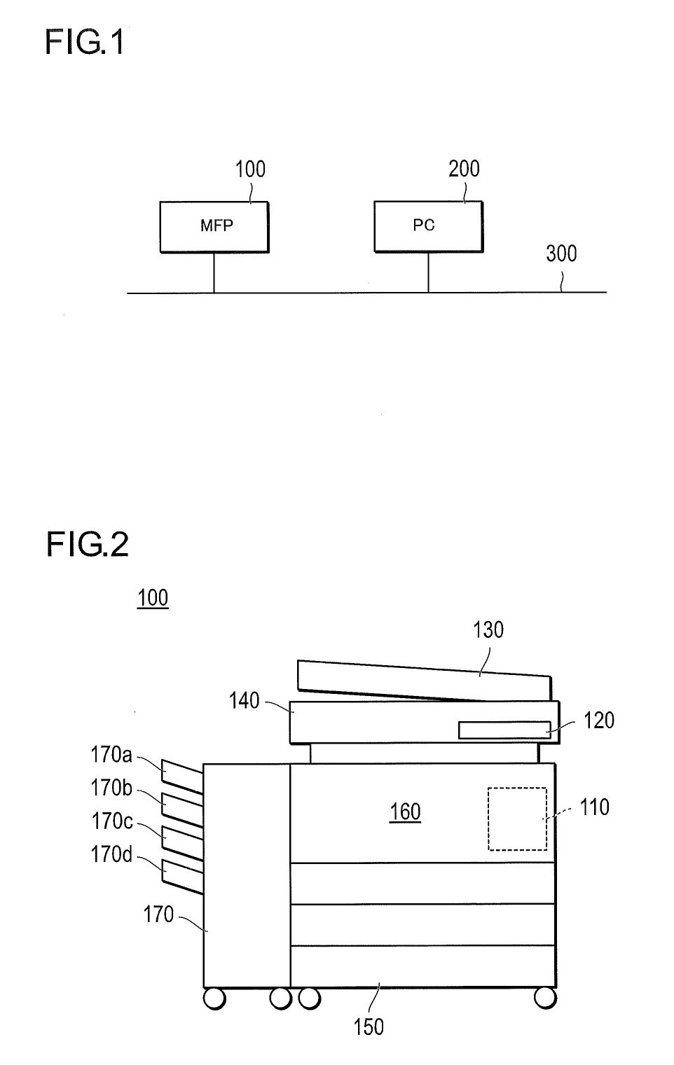

FIG. 1 is a block diagram showing the overall configuration of a printing processing system according to an embodiment of the present invention.

The printing processing system of the present embodiment is equipped with an MFP 100 as an image forming apparatus and a PC (Personal Computer) 200 as a printing instruction apparatus, which are connected via a network 300 so that they can communicate with each other.

The network 300 consists of a LAN (Local Area Network) that connects computers and network equipment with each other based on standards such as Ethernet, TokenRing, and FDDI (Fiber Distributed Data Interface), a WAN (Wide Area Network) that connects LANs via dedicated lines, etc. The types and quantities of equipment connected to the network 300 are not limited to the example shown in FIG. 1. The MFP 100 and the PC 200 can be connected directly (locally connected) without recourse to the network 300.

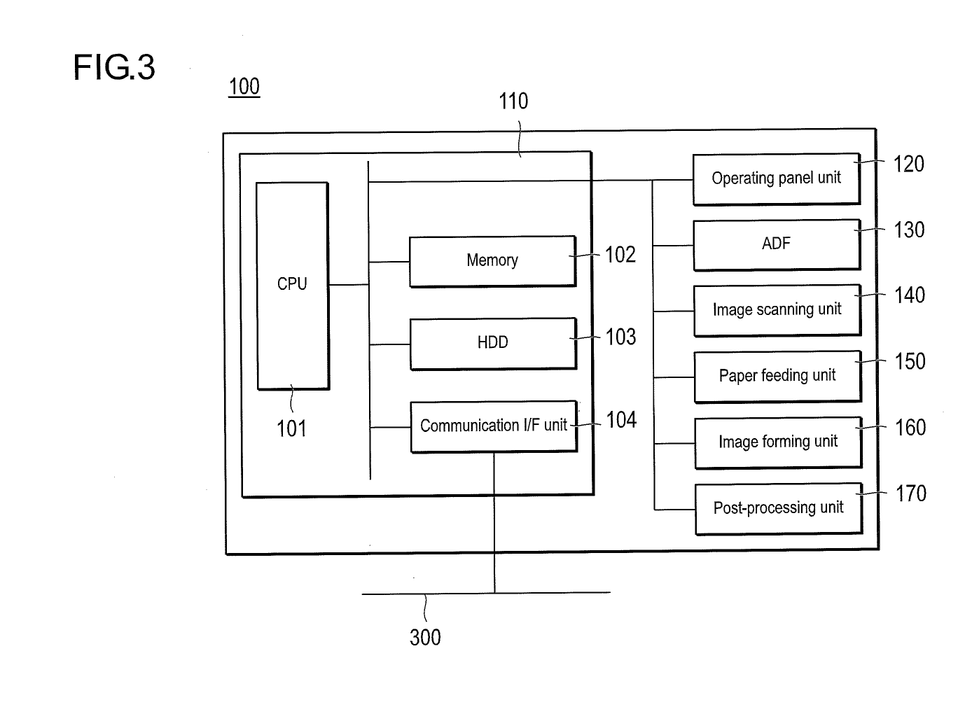

FIG. 2 is a schematic front view showing the configuration of the MFP shown in FIG. 1, while FIG. 3 is a block diagram showing the configuration of the MFP shown in FIG. 1.

The MFP 100 is equipped with a control unit 110, an operating panel unit 120, an ADF (Auto Document Feeder) 130, an image scanning unit 140, a paper feeding unit 150, an image forming unit 160, and a post-processing unit 170, all of which are connected with each other via a bus in order to exchange signals.

The control unit 110 has a CPU (Central Processing Unit) 101, a memory 102, an HDD (Hard Disk Drive) 103, and a communication I/F (Interface) unit 104.

The CPU 101 controls various units described above and executes multiple types of arithmetic operations in accordance with its program. The memory 102 is equipped with a ROM (Read Only Memory) in which various programs and multiple types of data are stored, a RAM (Random Access Memory) where the programs and data are temporarily stored, etc.

The HDD 103 stores various programs including the operating system and multiple types of data. The HDD 103 stores a program for generating image data of the bitmap format by translating the PDL (Page Description Language) data received from the PC 200, a program for generating image data for carbon copy printing by means of editing or fabricating the image data, and a program for controlling the operation of the post-processing unit 170.

The communication I/F unit 104 is an interface for communicating with other kinds of equipment via the network 300, in which standards such as Ethernet, Token Ring and FDDI are used.

The operating panel unit 120 is equipped with a touch-screen, a numeric keypad, a start button, a stop button, etc. , and is used for displaying various kinds of information and entering various instructions.

The ADF 130 transports a document consisting of multiple pages placed in it one sheet at a time to a designated scanning position of the image scanning unit 140, and discharges the document sequentially after scanning.

The image scanning unit 140 irradiates the document which is manually set at the designated scanning position, or automatically transferred to the designated scanning position by the ADF 130, with a light source such as a fluorescent lamp, and converts the light reflected from the document by an imaging apparatus such as a CCD (Charge Coupled Device) image sensor in order to generate image data from its electrical signal.

The paper feeding unit 150 stores sheets of paper used as a recording medium in printing. The paper feeding unit 150 is equipped with a plurality of paper feeding trays and feeds the sheets of paper stored in the paper feeding tray one sheet at a time to the image forming unit 160.

The image forming unit 160 forms images on the sheet of paper based on various data using a publicly known imaging process such as an electronic photography process consisting of various steps such as charging, exposing, developing, transferring and fixing steps.

The post-processing unit 170 performs designated post-processes (hereinafter referred to as “finishing process”) on the sheet of paper after the printing as it is transported from the image forming unit 160. The finishing process includes, e.g., a stapling process in which a bunch of paper is stitched with staples, a punching process in which holes are punched at the edge of the sheet of paper for filing, and a paper discharging process for discharging the sheet of paper to a specific paper discharge tray among the plurality of paper discharge trays 170a-170d. In other words, the post-processing unit 170 has a function of serving as a stapling process unit, a punching process unit, and a paper discharging process unit.

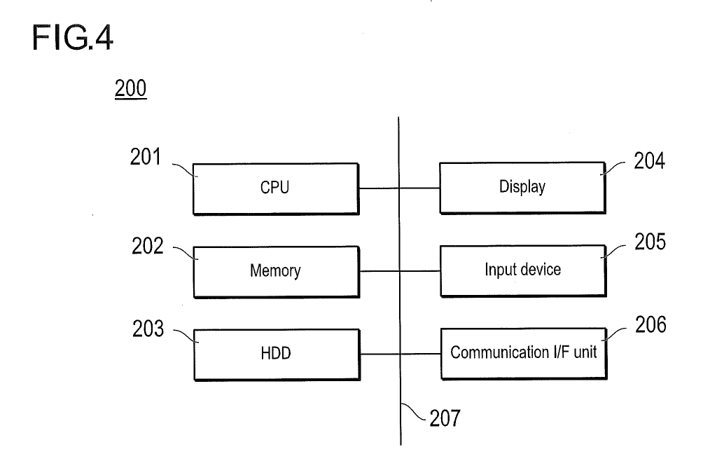

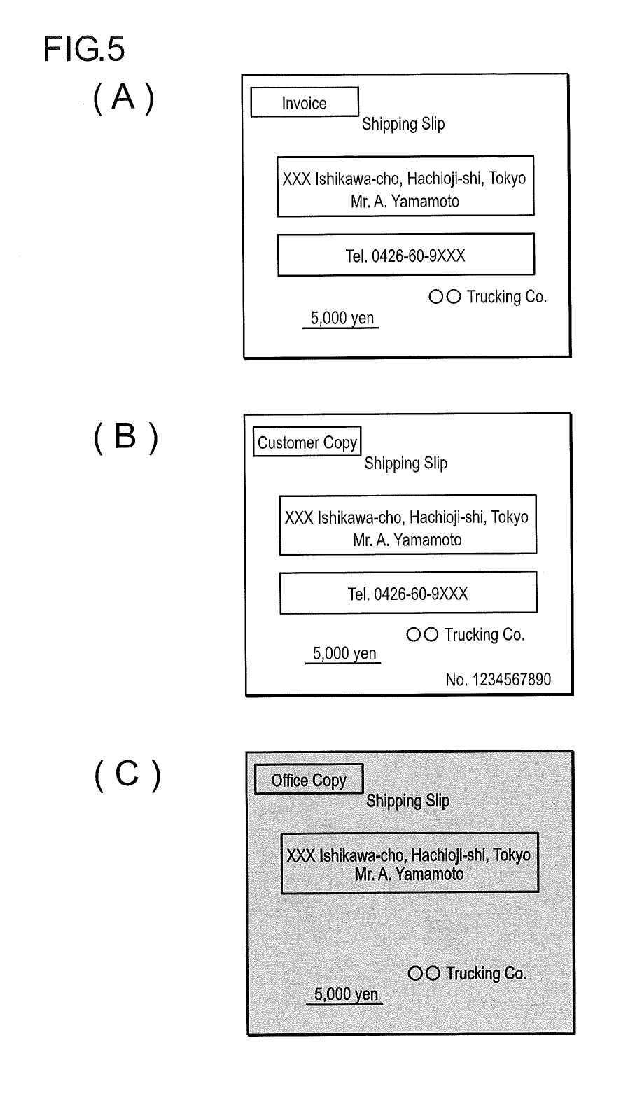

FIG. 4 is a block diagram showing the configuration of the PC shown in FIG. 1. The PC 200 is equipped with a CPU 201, a memory 202, a HDD 203, a display 204, an input device 205, and a communication I/F unit 206, all of which are interconnected via a bus 207 in order to exchange signals between them. The descriptions of those units of the PC 200 that have the same functions as those of the corresponding units of the MFP 100 will be omitted here to avoid being duplicative.

The HDD 203 is installed with an application for preparing document data and a printer driver for converting document data into PDL data described in a page description language that the MFP 100 can understand. The application used for preparing document data includes Microsoft Word (registered trade name) and Adobe Illustrator (registered trade name) as well as applications used specifically for variable printing.

The display 204 is typically a liquid crystal display capable of displaying multiple types of information. The input device 205 includes a pointing device such as a mouse or a keyboard, and is used for executing various inputs.

The MFP 100 and the PC 200 may each include components other than those components mentioned above or may lack a portion of those components mentioned above.

FIG. 5 is a drawing showing an example of multiple types of documents produced by a carbon copy printing process.

In a carbon copy printing process, multiple types of image data are generated from a document data according to one printing instruction of the user. Consequently, multiple types of documents are produced as multiple types of images are formed on different sheets of paper based on multiple types of image data.

FIG. 5(A) is a drawing showing an example of original document produced in the carbon copy printing process, while FIG. 5(B) and FIG. 5(C) show examples of the first and second carbon copy documents. In the present embodiment, three types of documents, i.e., “Invoice” which is the original document, “Customer Copy” which is the first carbon copy document, and “Office Copy” which is the second carbon copy document are produced from a single document data.

As shown in FIG. 5(A) and FIG. 5(B) , the text “Invoice” placed on the top left corner of the original document is changed to “Customer Copy” in the first carbon copy document. Also, a serial number (No. 1234567890) is added to the first carbon copy document.

On the other hand, as shown in FIG. 5(A) and FIG. 5(C), the text “Invoice” placed on the top left corner of the original document is changed to “Office Copy” in the second carbon copy document. The telephone number written on the original document is deleted in the second carbon copy document. Moreover, the background color is changed from white to blue in the second carbon copy document.

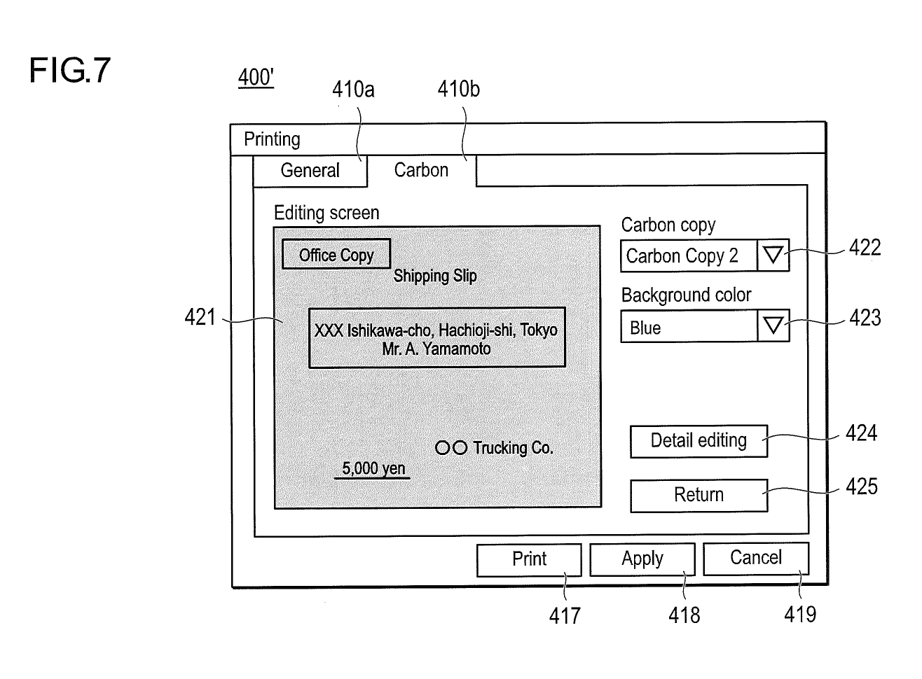

Such a change can be implemented by the user using a carbon copy editing screen 400′ (see FIG. 7) provided by the printer driver. In the printing processing system of the present embodiment, a designated finishing process can be performed on a specific type of document designated by the user among the abovementioned three types of documents produced according to the user's single printing instruction.

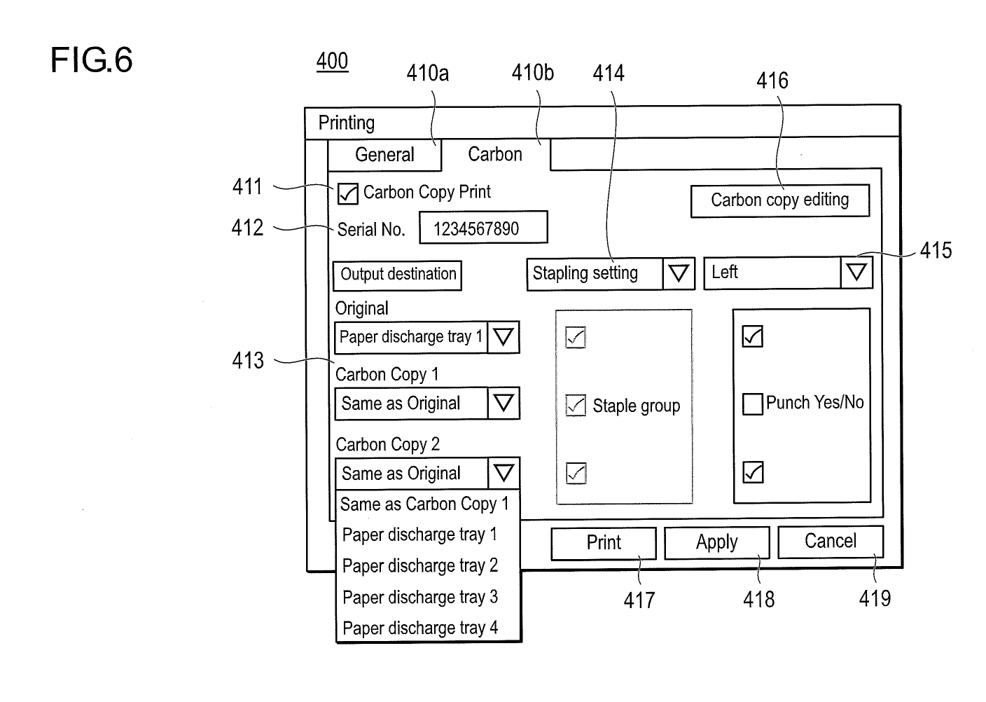

FIG. 6 is a drawing showing an example of printing setting screen displayed on the display of the PC. A printing setting screen 400 is displayed on the display 204 of the PC 200 as the printer driver is activated. The user of the PC 200 can set up the printing condition concerning carbon copy printing using the printing setting screen 400.

The printing setting screen 400 has a plurality of tabs 410a and 410b. As the “Carbon” tab 410b is selected from the plurality of tabs 410a and 410b, the screen for setting the printing condition concerning carbon copy printing appears.

The printing setting screen 400 has a carbon copy printing instruction part 411, a serial number input part 412, a paper discharge tray setting part 413, a stapling setting part 414, and a punching setting part 415. Moreover, the printing setting screen 400 is provided with a carbon copy editing button 416, a print button 417, an apply button 418, and a cancel button 419.

The carbon copy printing instruction part 411 accepts an instruction on whether or not to execute the carbon copy printing process. The carbon copy printing instruction part 411 has a check box to accept a selection by the user on whether or not to execute the carbon copy printing process.

The serial number input part 412 accepts the input of the serial number added to the specific type of document among multiple types of documents produced by the carbon copy printing process. The serial number input part 412 has an input box to accept an input of the serial number by the user.

The paper discharge tray setting part 413 accepts the setting of the paper discharge trays to which multiple types of documents produced by the carbon copy printing process will be discharged. The paper discharge tray setting part 413 has pull-down menus for selecting a paper discharge tray in order to accept the user's selection of a paper discharge tray for each of the original document, the first carbon copy document, and the second carbon copy document (corresponding to “Original,” “Carbon Copy 1,” and “Carbon Copy 2” of FIG. 6). In FIG. 6, “paper discharge tray 1” is selected as the destination of the original document, and “same as original” (i.e., paper discharge tray 1) is selected as the destination of the first and second carbon copy documents.

The stapling setting part 414 accepts the setting of the stapling process for multiple types of documents produced by the carbon copy printing process. The stapling setting part 414 has three check boxes corresponding to the original document, the first carbon copy document, and the second carbon copy document in order to accept the user's selection on a document to be stapled. The stapling setting part 414 has a pull-down menu in order to accept the user's selection on the stapling position of the sheet of paper to be stapled. In FIG. 6, the stapling process is not set up, and the three check boxes are grayed out.

The punching setting part 415 accepts the setting of the punching process for multiple types of documents produced by the carbon copy printing process. The punching setting part 415 has three check boxes corresponding to the original document, the first carbon copy document, and the second carbon copy document in order to accept the user's selection on a document to be punched. The punching setting part 415 has a pull-down menu in order to accept the user's selection on the punching position (left, top, etc.) of the sheet of paper to be punched. In FIG. 6, “Left” side is selected as the position where the punched holes will be formed and the original document and the second carbon copy document are selected as the two documents which will be punched.

In the printing setting screen 400 of the present embodiment, expressions such as “Original,” “Carbon Copy 1,” and “Carbon Copy 2” are used as the information to identify the three types of document. However, the expressions such as “Invoice,” “Customer Copy,” and “Office Copy” may be used instead, different from the present embodiment. Moreover, the number of the types of documents produced by the carbon copy printing process is not limited to three, but rather, an item that corresponds to “Carbon Copy 3” is added to the printing setting screen 400 if there are four types of documents will be produced by the carbon copy printing process.

FIG. 7 is a drawing showing an example of carbon copy editing screens. The carbon copy editing screen 400′ will be displayed on the display 204 as the carbon copy editing button 416 of the printing setting screen 400 is depressed. The user of the PC 200 can edit multiple types of documents produced by the carbon copy printing process using the carbon copy editing screen 400′.

The carbon copy editing screen 400′ has an image display part 421, an image selection part 422, and a background color setting part 423. Also, the carbon copy editing screen 400′ is provided with a detail editing button 424 and a “Return” button 425.

The image display part 421 displays one of the three types of documents which will be produced by the carbon copy printing process. In the present embodiment, the image data for display purpose is generated based on the document data and the image based on the image data is displayed on the image display part 421.

The image selection part 422 accepts the selection of the document which will be displayed on the image display part 421. The image selection part 422 has a pull-down menu and accepts the user' s selection of one of the three types of documents which will be displayed on the image display part 421.

The background color setting part 423 accepts the setting for the background color of the document. The background color setting part 423 has a pull-down menu and accepts the user' s selection of the background color for the document which will be displayed on the image display part 421.

The detail editing button 424 is a button provided for detail edition of the document displayed on the image display part 421 and used to call up a screen (not shown) for masking or adding a serial number to the preview image. The “Return” button 425 is a button for returning to the printing setting screen 400.

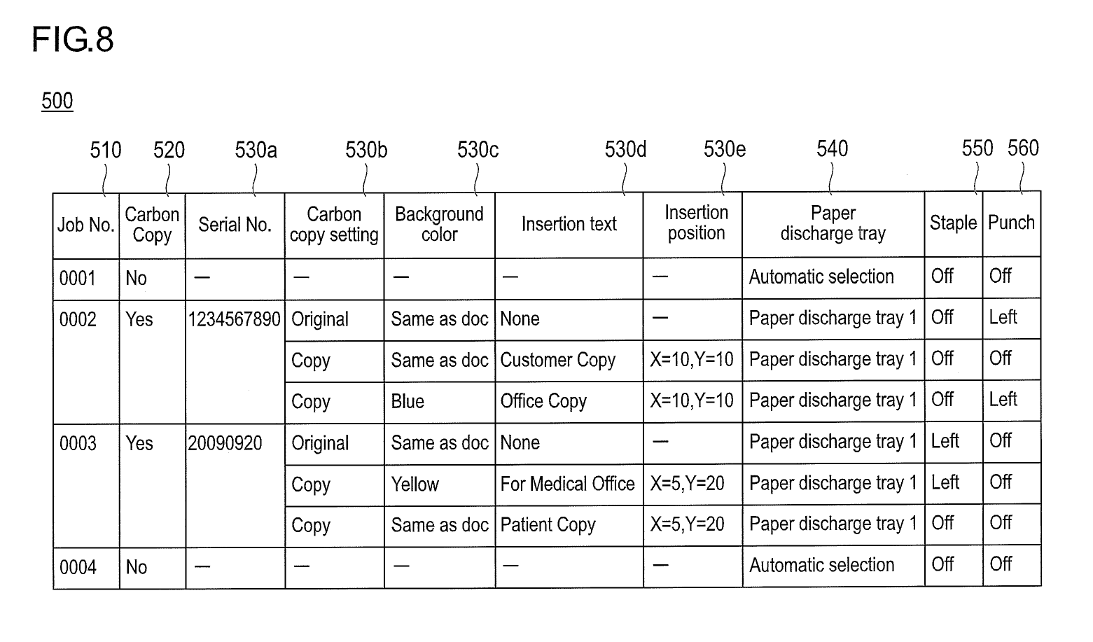

FIG. 8 is an example of printing setting information. The printing setting information 500 is generated by the PC 200 based on the setting contents of the printing setting screen 400.

The printing setting information 500 has job number information 510, carbon copy information 520, carbon copy printing setting information 530a-530e, paper discharge tray information 540, stapling information 550, and punching information 560.

The job number information 510 is information for identifying a print job.

The carbon copy information 520 is information to make a judgment on whether or not to execute the carbon copy printing process. The carbon copy information 520 corresponds to the setting of the carbon copy printing instruction part 411 of the printing setting screen 400, and “Yes” is set up as the information to indicate that the carbon copy printing process is set up when printing execution is instructed while the check box of the carbon copy printing instruction part 411 is checked.

The carbon copy printing setting information 530a-530e is information related to the carbon copy printing and contains serial number information 530a, carbon copy setting information 530b, background color information 530c, insertion text information 530d, and insertion position information 530e. The serial number information 530a is information for indicating a serial number which will be added to a specific type of document, and the carbon copy setting information 530b is information for identifying multiple types of image data generated from a single document data. The background color information 530c is information for indicating the background color of the image data, while the insertion text information 530d and the insertion position information 530e are the information for indicating the text which is changed according to the purpose of the document and its insertion position.

The paper discharge tray information 540 is information for indicating the paper discharge tray to which the specific document will be discharged. The paper discharge tray information 540 corresponds to the setting of the paper discharge tray setting part 413 of the printing setting screen 400, and can be set up individually for the three types of documents when the carbon copy printing is set up.

The stapling information 550 is information concerning whether or not to execute a stapling process on a document. The stapling information 550 corresponds to the setting of the stapling setting part 414 of the printing setting screen 400, and can be set up individually for the three types of documents when the carbon copy printing is set up.

The punching information 560 is information concerning whether or not to execute a punching process on a document. The punching information 560 corresponds to the setting of the punching setting part 415 of the printing setting screen 400, and can be set up individually for the three types of documents when the carbon copy printing is set up.

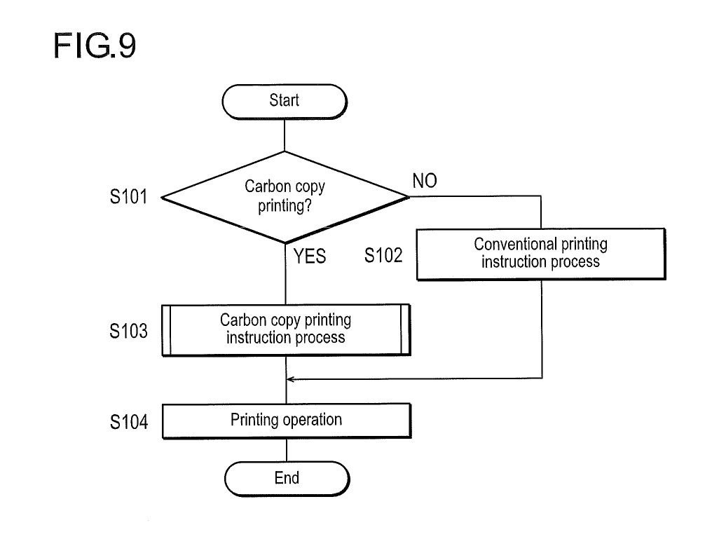

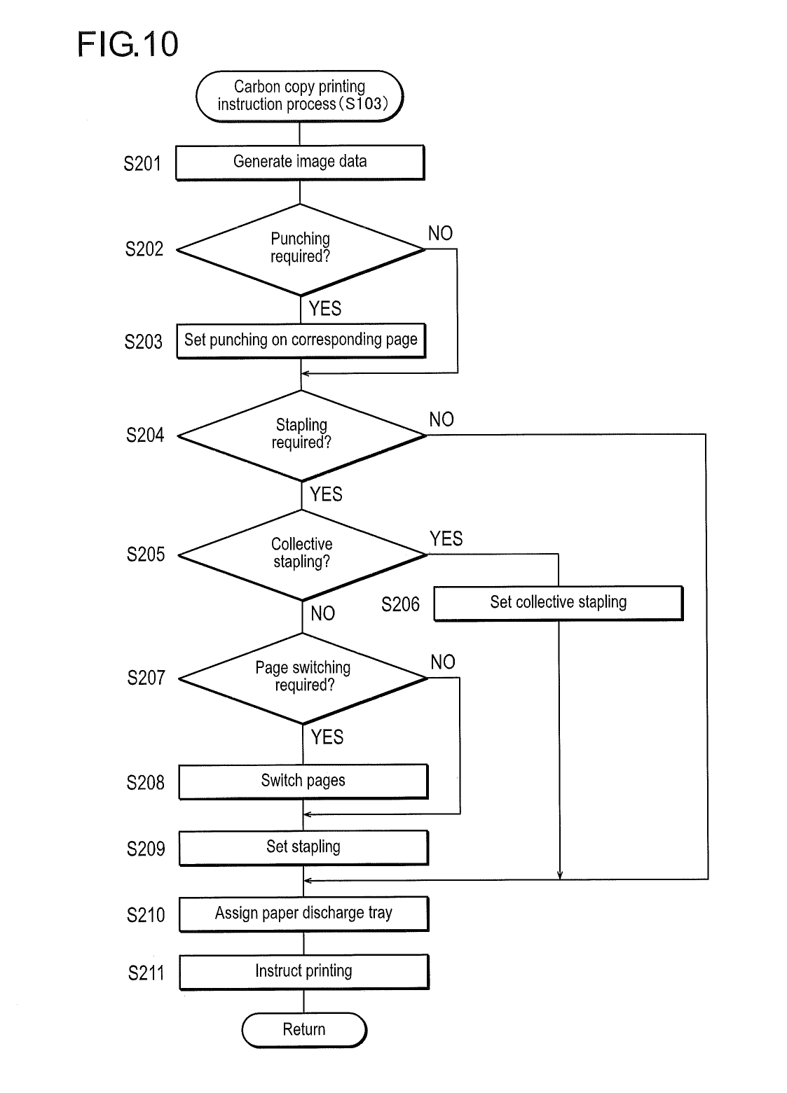

The printing setting information 500 is transmitted together with the corresponding document data to the MFP 100 as a print job. Upon receiving the print job, the MFP 100 executes the printing process based on the printing setting information 500. The operation of the MFP 100 is described below with reference to FIG. 9 and FIG. 10.

FIG. 9 is a flowchart showing a procedure of the printing process executed on the MFP. The algorithm shown in the flowchart of FIG. 9 is stored as a program in the HDD 103 of the MFP 100 and is executed by the CPU 101.

In the printing process, a judgment is made as to whether or not the carbon copy printing is set up first (step S101). In the present embodiment, a print job is analyzed and a judgment is made as to whether or not the carbon copy printing is set up based on the carbon copy information 520 contained in the print job.

If it is judged that the carbon copy printing is not set up (step S101: No), a conventional printing instruction process is executed (step S102). In the present embodiment, image data of the bitmap format is generated from the PDL data contained in the print job and is transmitted to the image forming unit 160. At this time, an operation command concerning the finishing process is set up based on the printing setting information 500 and is transmitted to the post-processing unit 170.

On the other hand, if it is judged in the process shown in step 5101 that the carbon copy printing is set up (step S101: Yes), the carbon copy printing instruction process is executed (step S103). In the present embodiment, multiple types of image data according to the purpose of the document are generated from the PDL data and are transmitted to the image forming unit 160. At this time, an operation command concerning the finishing process is set up based on the printing setting information 500 and is transmitted to the post-processing unit 170. The detail of the carbon copy printing instruction process shown in the step S103 will be described later.

The printing operation is then executed (step S104) and the process is terminated. In the present embodiment, the image is formed on the sheet of paper based on the image data generated in the process shown in the step S102 or the step S103. Then, the designated finishing process is performed on the sheet of paper on which the image is formed in accordance with the operation command.

FIG. 10 is a flowchart showing a procedure of the carbon copy printing instruction process shown in step S103 of FIG. 9.

In the carbon copy printing instruction process, multiple types of image data are generated first (step S201). In the present embodiment, the image data for the original document is generated first from the PDL data contained in the print job. Next, the image data for the first and second carbon copy documents are generated as the process for the masking process, the serial number addition process, the background color change process, etc., are applied to the image data for the original document. Since the process of generating multiple types of image data from a single document data itself is nothing but a common image data generating process for carbon copy printing, detail description for it is omitted here.

Next, a judgment is made as to whether or not the punching process is required (step S202). In the present embodiment, a print job is analyzed and a judgment is made as to whether or not a punching process is required based on the punching information 560 contained in the print job. For example, in case of the print job of the job number “0002” in FIG. 8, it is judged that a punching process is required as the punching information 560 of the original document and the second carbon copy document (Office Copy) is set up as “Left”.

If it is judged that the punching process is not required (step S202: No), it moves on to the step S204. On the other hand, if it is judged that the punching process is required (step S202: Yes), a punching process is set up for the corresponding page (step S203). In the present embodiment, an operation command is set up to cause a punching process to be performed by the post-processing unit 170 on the document for which a punching process is designated in a print job. For example, in case of the print job of the job number “0002” shown in FIG. 8, an operation command is set up to form punched holes on the original document which will be output as the first page and on the second carbon copy document which will be output as the third page. The post-processing unit 170 of the present embodiment can form punched holes on each page individually.

Next, a judgment is made as to whether or not the stapling process is required (step S204). In the present embodiment, a print job is analyzed and a judgment is made as to whether or not a stapling process is required based on the stapling information 550 contained in the print job.

If it is judged that the stapling process is not required (step S204: No), it moves on to the step S210. On the other hand, if it is judged that the stapling process is required (step S204: Yes), a judgment is made as to whether it is a collective stapling process or not (step S205). In the present embodiment, a judgment is made as to whether or not the stapling process is designated for all three types of documents. For example, in case of the print job of the job number “0003” in FIG. 8, it is judged that it is not a collective stapling process as stapling information 550 is designated as “Left” for the original document and the first carbon copy document (for medical office), while there is no stapling information 550 for the second carbon copy document (patient copy).

If it is judged that it is a collective stapling process (step S205: Yes), a collective stapling process is set up (step S206). In the present embodiment, an operation command is set up so that the three types of documents are stapled together.

On the other hand, if it is judged that it is not a collective stapling process (step S205: No), a judgment is made as to whether or not a page switching is required (step S207). For example, it is judged that a page switching is required if the stapling process is designated only for the original document which is output as the first page and the second carbon copy document which is output as the third page, of the three types of documents.

If it is judged that a page switching is not required (step S207: No), it moves on to the step S209. On the other hand, if it is judged that a page switching is required (step S207: Yes), pages are switched (step S208). For example, if the stapling process is designated only for the original document which is output as the first page and the second carbon copy document which is output as the third page, the sending order of the image data is changed to issue images from the image forming unit 160 in the order of the original document, the second carbon copy document, and the first carbon copy document.

Next, the stapling process is set up (step S209). In the present embodiment, for example, an operation command is set up in such a way as to have the two documents of the three types of documents issued as the first page and the second page to be stapled together.

Next, the paper discharge trays are assigned (step S210) . In the present embodiment, a print job is analyzed and paper discharge trays are assigned for each document based on the paper discharge tray information 540 contained in the print job. More specifically, an operation command is set up in such a way as to cause each document to be discharged to the paper discharge tray designated in the paper discharge tray information 540.

The carbon copy printing is then instructed (step S211) and the process is terminated. In the present embodiment, multiple types of image data are transmitted to the image forming unit 160, while an operation command concerning the finishing process is transmitted to the post-processing unit 170 as well. Consequently, multiple types of documents are first formed as multiple types of images are formed on different sheets of paper based on multiple types of image data. The designated finishing process is then performed on the sheets of paper on which the images are formed based on the specific types of image data (i.e., specific types of documents).

For example, for the print job of the job number “0002” in FIG. 8, punched holes are formed on the original document (Invoice) and the second carbon copy document (Office Copy) which are output as the first and third pages, while no punched hole is formed on the first carbon copy document (Customer Copy) which is output as the second page.

As can be seen from the above, according to the printing processing system of the present embodiment, a designated finishing process is performed on a specific type of document among multiple types of documents produced by the carbon copy printing process. Thus, the user can set up a finishing process for each document individually in consideration of the purpose of each document. More specifically, the user can form punched holes only on designated document. Also, the user can staple only the designated documents, while eliminating certain other designated documents from the scope of stapling. Moreover, the user can sort out documents by changing paper discharge trays in accordance with the purposes of documents.

In the embodiment described above, the finishing process is performed on the specific type of document as the user set up the printing condition directly using the printing setting screen 400 of the printer driver. However, different from the present embodiment, it can also be configured in such a way that the printing condition is automatically set up based on the information added to the document data.

More specifically, for example, information concerning a characteristic mark representing a specific finishing process can be added to the form data of the overlay form by the user' s operation, when the user prepare document data. Such a characteristic mark contained in the image of the document which is displayed on the application screen is recognized by the function of the printer driver, and the printing setting information 500 is generated for performing the finishing process specified by the recognized mark on a specific type of document. In this case, multiple types of form data are generated at the application so as to specify the sheet of paper on which the finishing process will be performed. The setting information which is specified by the image recognition can be reflected upon the printing setting screen 400. With such a configuration, the user' s operation of directly setting the printing condition using the printing setting screen 400 can be made unnecessary.

The present invention is not limited to the embodiment described above, but also can be modified in a various way within the claims.

For example, in the above embodiment, finishing processes such as the stapling process, the punching process, and the paper discharging process are performed on the sheet of paper on which the image is formed based on the specific type of image data. However, the finishing process should not be limited to those mentioned in the above embodiment, but rather includes, for example, a folding process for folding the sheet of paper on which the image is formed based on the specific type of image data (i.e., specific type of document).

Also, multiple types of image data are generated in the MFP 100 in the above embodiment. However, it is also possible to have multiple types of image data to be generated in the PC 200 and transmitted to the MFP 100.

Also, a case of executing the carbon copy printing process by means of the MFP was explained in the above embodiment. However, the carbon copy printing process can be executed in a printing process system that includes a printer and a printer controller, or in a printer having a printer controller built in.

The units and method of conducting various processes in the printing processing system according to the present embodiment can be realized either by a dedicated hardware circuit, or by a programmed computer. The above program can be provided either by a computer readable recording medium such as a flexible disk or CD-ROM, or on-line via a network such as the Internet. In such a case, the program recorded on the computer readable recording medium is normally transferred to and stored on a storage unit such as a hard disk. Also, the above program can be either provided as a standalone application software program or can be built into the software of a printing processing system as one of its function.

What is claimed is:

1. A printing processing system comprising:
an image data generating unit for generating multiple types of image data, each of which corresponds to each individual purpose of document data, deriving from said document data; and
a control unit for executing a control for performing a designated post-process on a sheet of paper on which an image is formed based on the specific type of image data among said multiple types of image data.

2. The printing processing system as claimed in claim 1, wherein
said post-process includes a punching process for forming punched holes on a sheet of paper, and said printing processing system further comprising:
a punching process unit for performing said punching process, wherein
said control unit controls an operation of said punching process unit in such a way as to form punched holes on the sheet of paper on which the image is formed based on said specific type of image data.

3. The printing processing system as claimed in claim 1, wherein
said post-process includes a stapling process for stapling multiple sheets of paper, and
said printing processing system further comprising:
a stapling process unit for performing said stapling process, wherein
said control unit controls an operation of said stapling process unit in such a way as to staple two or more sheets of paper on each of which an image is formed based on one of the two or more types of image data among said multiple types of image data.

4. The printing processing system as claimed in claim 1, wherein
said post-process includes a paper discharging process for discharging a sheet of paper to a designated paper discharge tray among a plurality of paper discharge trays, and
said printing processing system further comprising:
a paper discharging process unit for performing said paper discharging process, wherein
said control unit controls an operation of said paper discharging process unit in such a way as to discharge the sheet of paper on which the image is formed based on said specific type of image data to a designated paper discharge tray.

5. The printing processing system as claimed in claim 1, further comprising:
a display control unit for displaying a printing setting screen for setting up printing conditions on a display unit, wherein
said control unit executes a control for performing said post-process on a sheet of paper on which an image is formed based on the image data designated by said printing setting screen.

6. The printing processing system as claimed in claim 5, wherein
said document data includes multiple types of form data corresponding to said multiple types of image data, and information concerning a characteristic mark which specifies the content of said post-process is added to a specific type of form data among said multiple types of form data, and
said printing processing system further comprising:
an image recognition unit for recognizing said characteristic mark contained in an image displayed on said display unit based on said multiple types of form data, wherein
said control unit executes a control for performing said post-process corresponding to said mark recognized by said image recognition unit on a sheet of paper on which an image is formed based on the image data corresponding to said specific type of form data.

7. The printing processing system as claimed in claim 6, further comprising:
a reflecting unit for reflecting the setting concerning said post-process specified by said mark recognized by said image recognition unit on said printing setting screen.

8. A printing processing method comprising:
(a) generating multiple types of image data, each of which corresponds to each individual purpose of document data, deriving from said document data; and
(b) executing a control for performing a designated post-process on a sheet of paper on which an image is formed based on the specific type of image data among said multiple types of image data.

9. The printing processing method as claimed in claim 8, wherein
said post-process includes a punching process for forming punched holes on a sheet of paper, and
in said step (b), an operation of a punching process unit for performing said punching process is controlled in such a way as to form punched holes on the sheet of paper on which the image is formed based on said specific type of image data.

10. The printing processing method as claimed in claim 8, wherein
said post-process includes a stapling process for stapling multiple sheets of paper, and
in said step (b), an operation of a stapling process unit for performing said stapling process is controlled in such a way as to staple two or more sheets of paper on each of which an image is formed based on one of the two or more types of image data among said multiple types of image data.

11. The printing processing method as claimed in claim 8, wherein
said post-process includes a paper discharging process for discharging a sheet of paper to a designated paper discharge tray among a plurality of paper discharge trays, and
in said step (b), an operation of a paper discharging process unit for performing said paper discharging process is controlled in such a way as to discharge the sheet of paper on which the image is formed based on said specific type of image data to a designated paper discharge tray.

12. The printing processing method as claimed in claim 8, further comprising:
(c) displaying a printing setting screen for setting up printing conditions on a display unit, wherein
in said step (b), a control is executed for performing said post-process on a sheet of paper on which an image is formed based on the image data designated by said printing setting screen.

13. The printing processing method as claimed in claim 12, wherein
said document data includes multiple types of form data corresponding to said multiple types of image data, and information concerning a characteristic mark which specifies the content of said post-process is added to a specific type of form data among said multiple types of form data, and
said printing processing method further comprising:
(d) recognizing said characteristic mark contained in an image displayed on said display unit based on said multiple types of form data, wherein
in said step (b), a control is executed for performing said post-process corresponding to said mark recognized in said step (d) on a sheet of paper on which an image is formed based on the image data corresponding to said specific type of form data.

14. The printing processing method as claimed in claim 13, further comprising:
(e) reflecting the setting concerning said post-process specified by said mark recognized in said step (d) on said printing setting screen.

15. An image forming apparatus comprising:
an image data generating unit for generating multiple types of image data, each of which corresponds to each individual purpose of document data, deriving from said document data;
a control unit for executing a control for performing a designated post-process on a sheet of paper on which an image is formed based on the specific type of image data among said multiple types of image data;
an image forming unit for forming an image on a sheet of paper based on said image data; and
a post-processing unit for performing said post-process on the sheet of paper on which the image is formed by said image forming unit.

16. The image forming apparatus as claimed in claim 15, wherein
said post-process includes a punching process for forming punched holes on a sheet of paper, and
said post-processing unit includes a punching process unit for performing said punching process, wherein
said control unit controls an operation of said punching process unit in such a way as to form punched holes on the sheet of paper on which the image is formed based on said specific type of image data.

17. The image forming apparatus as claimed in claim 15, wherein
said post-process includes a stapling process for stapling multiple sheets of paper, and
said post-processing unit includes a stapling process unit for performing said stapling process, wherein
said control unit controls an operation of said stapling process unit in such a way as to staple two or more sheets of paper on each of which an image is formed based on one of the two or more types of image data among said multiple types of image data.

18. The image forming apparatus as claimed in claim 15, wherein
said post-process includes a paper discharging process for discharging a sheet of paper to a designated paper discharge tray among a plurality of paper discharge trays, and
said post-processing unit includes a paper discharging process unit for performing said paper discharging process, wherein
said control unit controls an operation of said paper discharging process unit in such a way as to discharge the sheet of paper on which the image is formed based on said specific type of image data to a designated paper discharge tray.
